(19) United States
(12) Patent Application Publication
(10) Pub. No.: US 2013/0237162 A1
(43) Pub. Date: Sep. 12, 2013

(54) MOBILE COMMUNICATION DEVICE

(71) Applicant: PANTACH CO., LTD., Seoul (KR)

(72) Inventor: Jong Cheal YOON, Seoul (KR)

(73) Assignee: Pantach Co., Ltd., Seoul (KR)

(21) Appl. No.: 13/748,958

(22) Filed: Jan. 24, 2013

(30) Foreign Application Priority Data
Mar. 7, 2012 (KR) 10-2012-0023485

(51) Int. Cl. H04B 1/38; H01Q 1/50

(52) U.S. Cl. CPC H04B 1/3827; H01Q 1/50
USPC 455/77; 343/750

(57) ABSTRACT

A mobile communication device includes an antenna unit to operate in multiple frequency bands by shifting the resonance frequency of the antenna using capacitors. A first capacitor unit may be formed by the disposal of a first electrode in a hole in a first antenna pattern and the formation of a second electrode in the portion of the first antenna pattern opposing the first electrode. The first capacitor unit may be formed in various ways to be activated by a switch. The connection of the first capacitor unit to a voltage supply and ground may trigger a shift in the resonant frequency of the first antenna pattern.

### CROSS-REFERENCE TO RELATED APPLICATION

This application claims priority from and the benefit of Korean Patent Application No. 10-2012-0023485, filed on Mar. 7, 2012, which is incorporated by reference for all purposes as if fully set forth herein.

### BACKGROUND

1. Field

The following description relates to a mobile communication device, and more particularly, to a mobile communication device including a frequency-tunable antenna to selectively shift a resonance frequency in a multi-band or single-band antenna module.

2. Discussion of the Background

As various kinds of mobile communication services have been commercialized for mobile communication devices, the number of resonance frequency bands supported by a single terminal is gradually increasing. In addition, in order to support global roaming without being limited to a specific communication service provider, mobile communication devices having an antenna capable of realizing multi-band and ultra wideband with a small size or volume are being studied to reduce the size and/or volume of the antenna and pursue slim products and enhanced designs.

Particularly, in a case of a terminal supporting Long Term Evolution (LTE), various tunable antennas or switching antennas are being studied to overcome the difficulty of realizing a wide band of an antenna.

However, tunable antennas are expensive, and may experience deteriorated emission efficiency in frequency bands other than the switching band. In other words, after switching between a high frequency band and a low frequency band, the frequency matching characteristic of the antenna may deteriorate in some frequency bands.

FIG. 1 is a schematic view illustrating a general antenna according to the related art. FIG. 1 is a circuitry diagram illustrating a general multi-band antenna. A wave traveling toward an antenna and a wave reflected from the antenna may be detected by a power detector 15, and a value of a digital-analog converter 12 may be digitally adjusted to maintain an amount of reflection from the antenna below a reference value so that an inductance value and a capacitance value in a tunable antenna module 11 may be controlled, thereby adjusting a matching value of the antenna in real time.

In the case of FIG. 1, an algorithm for performance optimization may be complicated, and a unit price of the general multi-band antenna may increase because an expensive tunable antenna module is applied. In addition, a complicated control circuit 13 is needed to control the complicated tunable antenna, and accordingly a board-mounting region for other components may fall short of what is needed. Moreover, since the capacitance value C and inductance value L to enlarge a frequency receiving bandwidth are great, a loss in board-mounting region increases due to the use of a concentrating element. Accordingly, a noise problem may occur in the antenna due to the application of an external DC power.

FIG. 2 is a schematic view illustrating a general antenna according to the related art. FIG. 2 is a circuitry diagram showing a configuration to switch to a selected frequency by controlling an antenna ground supply location. Various matching circuits may be implemented by using a first switch 22 and a second switch 23.

Referring to FIG. 2, by adjusting resonance length L₁ and resonance length L₂ of the antenna if the first switch 22 is connected and if the second switch 23 is connected, the resonance frequency may be shifted.

In the case of FIG. 2, the degree of frequency shifting varies according to a separation distance D between the two switches, which are the ground source. If the distance from a signal supply pin increases over a reference level, an antenna matching characteristic of a specific frequency band may deteriorate. Therefore, if great frequency shifting is required, frequency bands not selected by the ON/OFF operation of the switch may have deteriorated characteristics. In addition, since the antenna pattern may be electrically connected to the DC power of the switch, noise may be generated by the power, which may cause deterioration in the sensitivity of the antenna.

FIG. 3A and FIG. 3B are graphs illustrating matching characteristics of antennas according to the related art. FIG. 3A illustrates a frequency matching characteristics before frequency shifting. FIG. 3B illustrates a frequency matching characteristic after frequency shifting.

Referring to FIG. 3A, before frequency shifting, the standing wave ratio may be close to 1 in both a high frequency band and a low frequency band, and thus it may be considered that excellent matching characteristics are ensured. However, referring to FIG. 3B, in a case where a frequency in a high frequency band shifts, it can be found that the shifted high frequency region has a standing wave ratio close to about 4. In other words, it may be seen that the noise increases when compared to the case before frequency shifting. Therefore, various attempts have been made to improve antenna emission efficiency, reduce noise, and improve matching characteristics.

### SUMMARY

Exemplary embodiments of the present invention provide a mobile communication device including a frequency-tunable antenna to selectively shift a resonance frequency in a multi-band or single-band antenna module.

Additional features of the invention will be set forth in the description which follows, and in part will be apparent from the description, or may be learned by practice of the invention.

An exemplary embodiment of the present invention discloses a mobile terminal including an antenna, including: a first antenna pattern line with a first length determined according to a first frequency to be received or transmitted by the first antenna pattern line; a first capacitor unit having a first electrode disposed on the first antenna pattern line and a second electrode disposed opposite the first electrode; and a first switch to selectively connect the second electrode to a ground to shift a resonant frequency of the first antenna pattern.

An exemplary embodiment of the present invention also discloses an antenna unit, including: an antenna pattern line; an electrode disposed opposite at least a portion of the antenna pattern line; a switch to selectively connect the electrode to a ground to shift a resonant frequency of the antenna pattern.

It is to be understood that both the foregoing general description and the following detailed description are exemplary and explanatory and are intended to provide further explanation of the invention as claimed. Other features and aspects will be apparent from the following detailed description, the drawings, and the claims.

### BRIEF DESCRIPTION OF THE DRAWINGS

The accompanying drawings, which are included to provide a further understanding of the invention and are incorporated in and constitute a part of this specification, illustrate embodiments of the invention, and together with the description serve to explain the principles of the invention

FIG. 1 is a schematic view illustrating a general antenna according to the related art.

FIG. 2 is a schematic view illustrating a general antenna according to the related art.

FIG. 3A and FIG. 3B are graphs illustrating matching characteristics of antennas according to the related art.

FIG. 4 is a circuitry diagram illustrating an antenna unit according to an exemplary embodiment of the present disclosure.

FIG. 5A and FIG. 5B are graphs illustrating a voltage distribution of an antenna according to an exemplary embodiment of the present disclosure.

FIG. 6 is a perspective view illustrating an antenna unit and a capacitor unit according to an exemplary embodiment of the present disclosure.

FIG. 7 is a circuitry diagram illustrating the antenna unit and the capacitor unit of FIG. 6.

FIGS. 8A, 8B, and 8C are graphs illustrating standing wave ratios according to an exemplary embodiment of the present disclosure.

FIG. 9 is a perspective view illustrating an antenna unit and a capacitor unit according to an exemplary embodiment of the present disclosure.

FIG. 10 is a circuitry diagram illustrating an antenna unit and a capacitor unit of FIG. 9.

FIGS. 11A, 11B, and 11C are graphs illustrating standing wave ratios according to an exemplary embodiment of the present disclosure.

FIG. 12 is a perspective view illustrating an antenna unit and a capacitor unit according to an exemplary embodiment of the present disclosure.

FIG. 13 is a circuitry diagram illustrating the antenna unit and the capacitor unit of FIG. 12.

FIG. 14A, FIG. 14B, and FIG. 14C are graphs illustrating standing wave ratios according to an exemplary embodiment of the present disclosure.

FIG. 15 is a perspective view illustrating an antenna unit and a capacitor unit according to an exemplary embodiment of the present disclosure.

FIG. 16 is a circuitry diagram illustrating the antenna unit and the capacitor unit of FIG. 15.

FIG. 17 is a graph illustrating a standing wave according to an exemplary embodiment of the present disclosure.

FIG. 18 is a perspective view illustrating an antenna unit and a capacitor unit according to an exemplary embodiment of the present disclosure.

FIG. 19A is a perspective view illustrating an antenna unit and a capacitor unit according to an exemplary embodiment of the present disclosure.

FIG. 19B is a rear view illustrating the antenna unit and the capacitor unit of FIG. 19A.

FIG. 20A and FIG. 20B are graphs illustrating matching characteristics of an antenna unit according to an exemplary embodiment of the present disclosure.

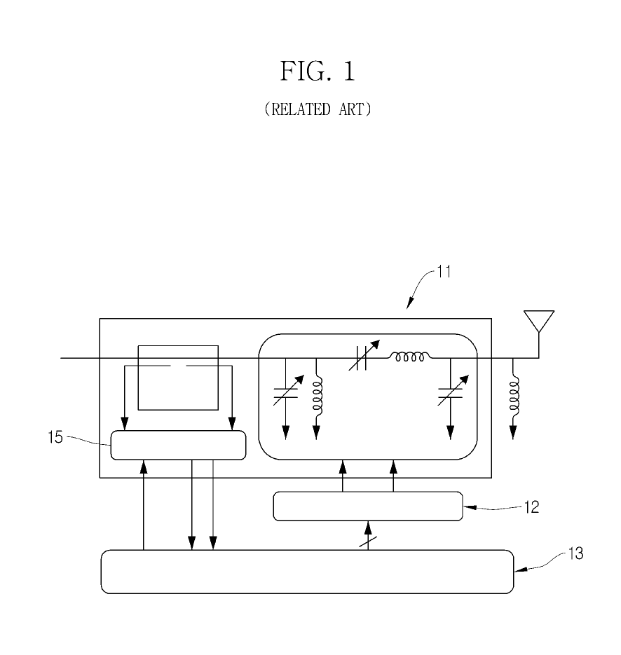

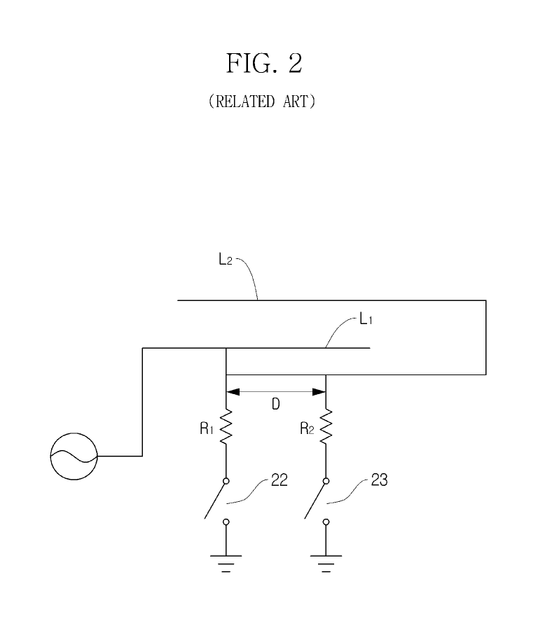

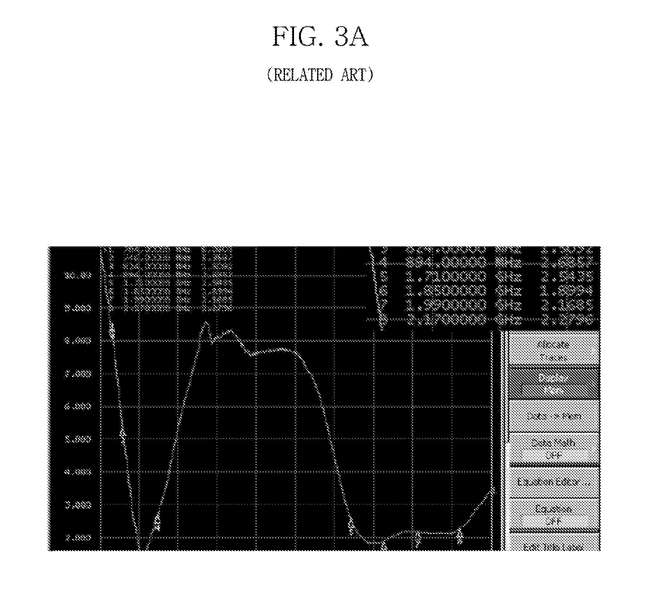

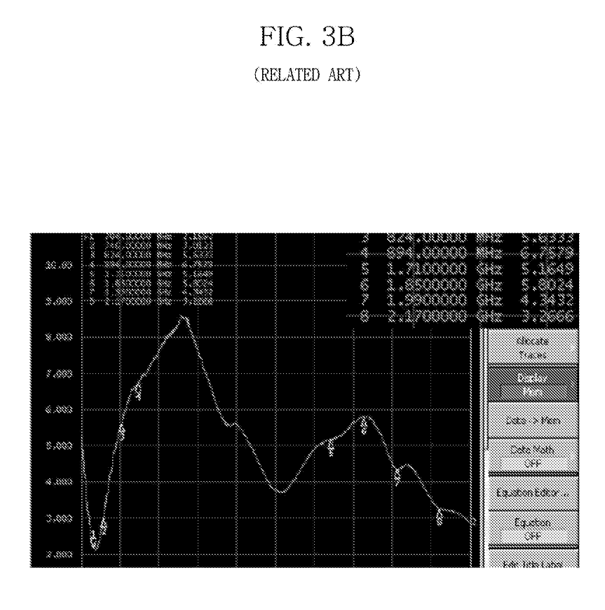

### DETAILED DESCRIPTION OF THE ILLUSTRATED EMBODIMENTS

Exemplary embodiments are described more fully hereinafter with reference to the accompanying drawings, in which embodiments of the invention are shown. This invention may, however, be embodied in many different forms and should not be construed as limited to the embodiments set forth herein. Rather, these embodiments are provided so that this disclosure is thorough, and will fully convey the scope of the invention to those skilled in the art. In the drawings, the size and relative sizes of layers and regions may be exaggerated for clarity Like reference numerals in the drawings denote like elements. Although features may be shown as separate, such features may be implemented together or individually. Further, although features may be illustrated in association with an exemplary embodiment, features for one or more exemplary embodiments may be combinable with features from one or more other exemplary embodiments.

It will be understood that when an element or layer is referred to as being “on” or “connected to” another element or layer, it can be directly on or directly connected to the other element or layer, or intervening elements or layers may be present. In contrast, when an element is referred to as being “directly on” or “directly connected to” another element or layer, there are no intervening elements or layers present. It will be understood that for the purposes of this disclosure, “at least one of X, Y, and Z” can be construed as X only, Y only, Z only, or any combination of two or more items X, Y, and Z (e.g., XYZ, XYY, YZ, ZZ).

Hereinafter, a mobile communication device including an antenna module according to exemplary embodiments of the present disclosure will be described in detail with reference the drawings.

An antenna module of a mobile communication device includes an antenna unit and a capacitor unit.

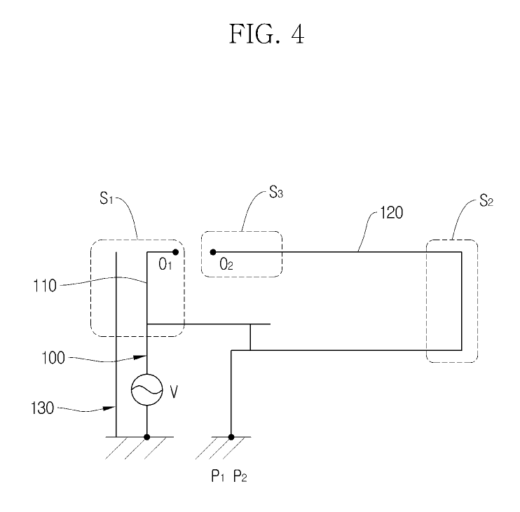

FIG. 4 is a circuitry diagram illustrating an antenna unit according to an exemplary embodiment of the present disclosure.

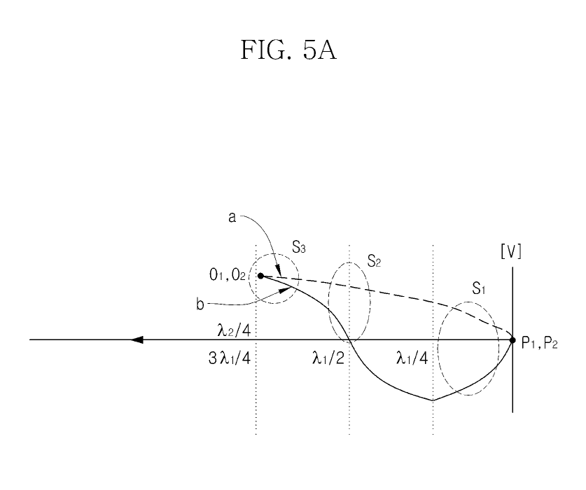

Referring to FIG. 4, an antenna unit 100 includes at least one antenna line with a reference length according to a wavelength of a frequency to be received, which has a first antenna pattern line 110 and a second antenna pattern line 120. The second antenna line 120 may be longer than the first antenna pattern line 110. The antenna unit may include a first region S₁, a second region S₂ and a third region S₃ and will be described below with reference to FIG. 5A and FIG. 5B.

The antenna unit 100 may be connected to a power supply V. The first antenna pattern line 110 and the second antenna pattern line 120 may include open point O₁, open point O₂, ground point P₁, and ground point P₂. Ground point P₁ and P₂ may be connected to a ground terminal. The antenna unit 100 may include a coupling ground line 130 electrically insulated and grounded from the first antenna pattern line 110 and second antenna pattern line 120. The coupling ground line 130 may be used to generate multi-resonance in a high frequency band.

The length of the first antenna pattern line 110 and the second antenna pattern line 120 may refer to a length along the first antenna pattern line 110 and the second antenna pattern line 120 from the open point O₁ and the open point O₂, respectively, to the ground point P₁ and the ground point P₂.

FIG. 5A and FIG. 5B are graphs illustrating voltage distribution of an antenna unit according to an exemplary embodiment of the present disclosure. Although FIG. 5A and FIG. 5B will described with reference to FIG. 4, aspects of the exemplary embodiments are not limited thereto.

Herein, a wavelength having a frequency of 2 GHz is used to represent a wavelength of a high frequency band, and a wavelength having a frequency of 700 MHz is used to represent a wavelength of a low frequency band; however, the exemplary embodiments are not limited thereto, and various wavelengths may be used in various high frequency bands and various low frequency bands.

FIG. 5A may be a graph illustrating voltage distribution based on the ground point P₁ and the ground point P₂, and FIG. 5B may be a graph illustrating voltage distribution based on the open point O₁ and the open point O₂.

Referring to FIG. 5A and FIG. 5B, in the case of the ground point P₁ and ground point P₂, the voltage may be 0 V due to grounding, and the open point O₁ and the open point O₂ may have a maximum potential due to the power supply V. The voltage distribution may be determined according to the frequency of a power supplied to the antenna unit 100. A line “a” represents voltage distribution if a frequency of a low frequency band is supplied and a line “b” represents voltage distribution if a frequency of a high frequency band is supplied.

Referring to FIG. 4, FIG. 5A and FIG. 5B, the first region S₁, the second region S₂ and the third region S₃ are regions of the antenna unit 100.

The first region S₁ is a region adjacent to the ground point P₁ of the first antenna pattern line 110, and the second region S₂ is a region between the open point O₂ and the ground point P₂ of the second antenna pattern line 120. Third region S₃ represents a region adjacent to the open point O₂ of the second antenna pattern line 120.

Referring to FIG. 5A, in the first region S₁, the voltage may be relatively high with respect to the frequency of a high frequency band, but the voltage may be relatively low in case of the frequency of a low frequency band. If the wavelength of a high frequency band received by the antenna unit is λ₁ and a wavelength of a low frequency band is λ₂, the first region S₁ may be a region from the ground point P₁ on the first antenna pattern line 110 to a ¼ point (λ₁/4) of the wavelength λ₁ of the high frequency band to be received.

Referring to FIG. 5A and FIG. 5B, in the second region S₂, the voltage may be close to 0 V in the frequency of the high frequency band, but the voltage may be relatively high in the low frequency band. The second region S₂ may be a region from the open point O₂ on the second antenna pattern line 120 between a ⅛ point (λ₁/8) and ⅜ point (3λ₁/8) of the wavelength λ₁ of the high frequency band to be received. However, the second region S2 is not limited thereto, and the second region S₂ may also be a region adjacent to a ⅛ point (λ₂/8) based on the wavelength λ₂ of the low frequency band.

The third region S₃ may be a region adjacent to the open point O₂, the voltage may be high in the high frequency band and the low frequency band. The third region S₃ may be a region from the open point O₂ on the second antenna pattern line 120 to a ⅛ point (λ₁/8) of the wavelength λ₁ of the high frequency band to be received.

A coupling capacitance C may be expressed by the following equation.

$$C = \frac{S \times V}{d}$$

The coupling capacitance C may be determined according to an opposite area S of two opposite electrodes that overlap with each other, a voltage V and a distance d between the opposite electrodes.

A capacitor unit may be included to form a coupling capacitance at the antenna unit 100.

The capacitor unit may include a first electrode disposed on the antenna unit, a second electrode electrically insulated from the first electrode and disposed to have a first opposite area which overlaps with the first electrode, and a switch to selectively connect the second electrode to a ground terminal. An opposite area may refer to the area of the second electrode which is disposed opposing the area of the first electrode and may correspond to the opposite area S.

The capacitor unit may include a partial region of the antenna unit, i.e., a partial region on the antenna pattern line, as the first electrode, and the second electrode to have a first opposite area disposed to be opposing to the first electrode such that the first electrode and the to second electrode may form a coupling capacitance.

The second electrode may be disposed to be selectively connected to a ground electrode such that a voltage difference is formed between the second electrode and the first electrode. The second electrode may be selectively connected to an active position if the second electrode is connected to the ground terminal to form a coupling capacitance and to an inactive position if the second electrode and the ground terminal are opened using the switch.

If the coupling capacitance is formed in the antenna unit 100, a resonance frequency may shift. An amount of frequency shifting may be adjusted according to the magnitude of the coupling capacitance. The coupling capacitance may be controlled by adjusting a potential difference V between the first electrode and the second electrode, an opposite area of the first electrode and the second electrode, or a distance d between the first electrode and the second electrode.

The capacitance of the capacitor unit may be determined according to the potential difference between the first electrode and the second electrode. Referring to FIG. 5A and FIG. 5B, because the voltage distribution on the antenna pattern line varies according to a location on the antenna pattern line, the magnitude of the coupling capacitance may be adjusted according to a location of the second electrode on the antenna line pattern.

If the capacitor units are formed in each of the first region S₁, the second region S₂ and the third region S₃, the coupling capacitance may be expressed as shown in Table 1 below according to the voltage distribution of the antenna pattern line, as described above.

TABLE 1

| | | | Coupling | Resonance |
|---|---|---|---|---|
| Position | Band | Voltage | capacitance | frequency |
| first region S₁ | high frequency | V₁ | C1 | fₕ-α |
| | low frequency | →0 | →0 | f_{L} |
| second region S₂ | high frequency | 0 | 0 | fₕ |
| | low frequency | V₂ | C2 | f_{L}-β |
| third region S₃ | high frequency | V₃₁ | C31 | fₕ-α |
| | low frequency | V₃₂ | C32 | f_{L}-β |

V₁ may represent a voltage according to a high frequency band in the first region S₁, V₂ may represent a voltage according to a low frequency band in the second region S₂, and V₃₁ and V₃₂, respectively, may represent voltages according to a high frequency band and a low frequency band in the third region S₃.

C₁ may represent a coupling capacitance from the capacitor unit formed in the first region S₁, C2 may represent a coupling capacitance from the capacitor unit formed in the second region S₂, and C31 and C32, respectively, may represent coupling capacitances of a component which influences the high frequency band and the low frequency band formed in the third region S₃.

If a capacitance is formed in the antenna unit 100, the resonance frequency of the antenna unit 100 may shift. Therefore, if frequency shifting is selected in the antenna unit 100, the capacitor unit may be formed in at least one of the first region S₁, the second region S₂, and the third region S₃.

If a capacitor unit is formed in each region, particularly in the first region S₁, the frequency of the high frequency band may shift from fₕ as much as α, but the frequency f_{L} of the low frequency band may be maintained. In the second region S₂, the frequency of the high frequency band may be maintained at fₕ, but the frequency f_{L} of the low frequency band may shift as much as β. In the third region S₃, the frequency of the high frequency band may shift from fₕ as much as α, and the frequency of the low frequency band may shift from f_{L} as much as β.

If the first capacitor unit is disposed in the first region such that the second electrode has an overlapping area, the frequency of the high frequency band may be selectively shifted. If the second capacitor unit is disposed in the second region S₂ such that the second electrode has an overlapping area, the frequency of the low frequency band may be selectively shifted. If the third capacitor unit is disposed in the third region such that the second electrode has an opposite area, the frequency may be shifted in both the high frequency band and the low frequency band.

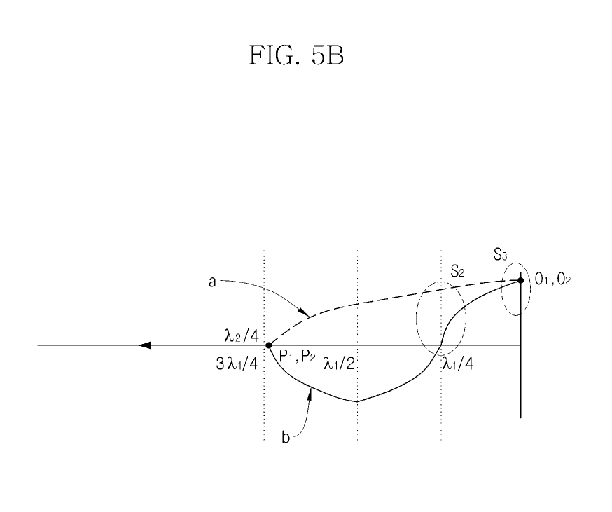

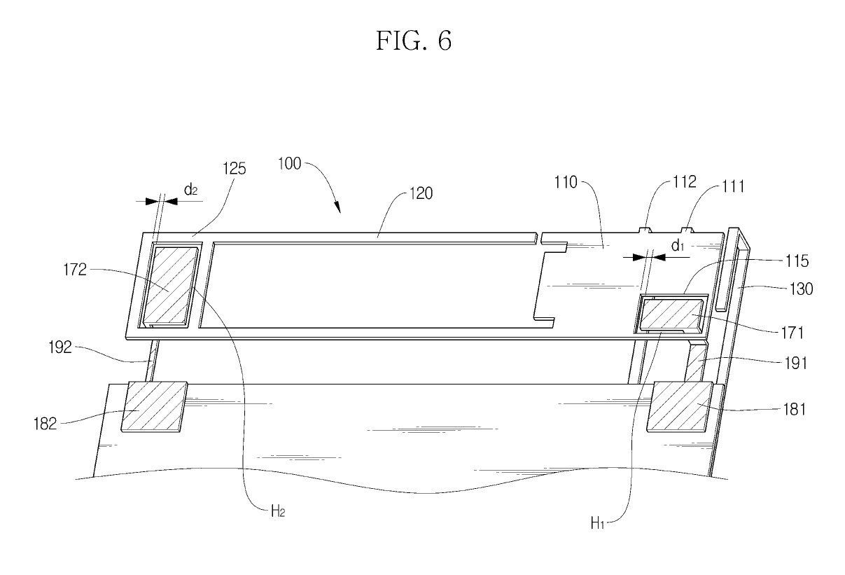

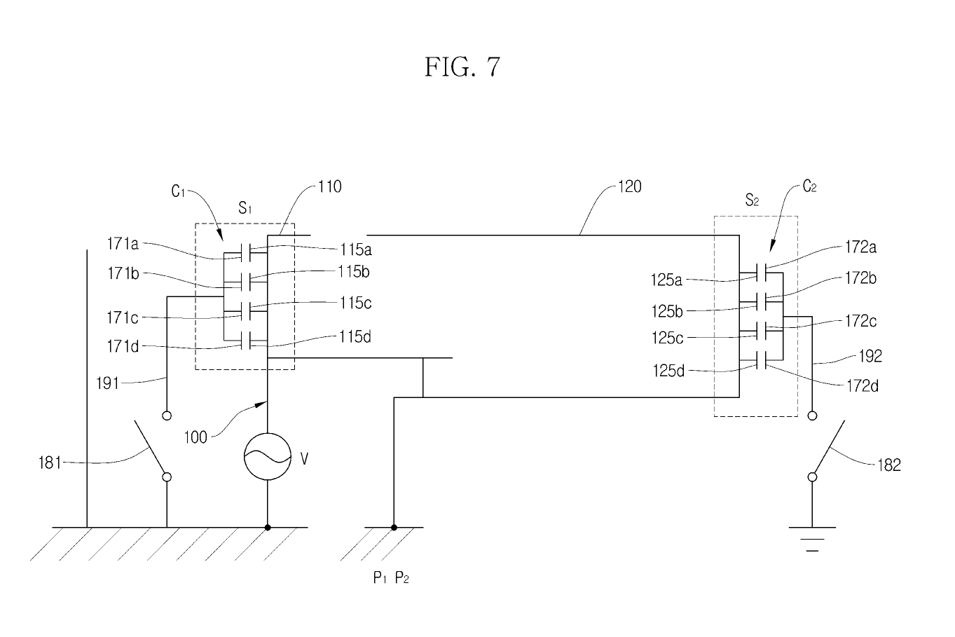

FIG. 6 is a perspective view illustrating an antenna unit and a capacitor unit according to an exemplary embodiment of the present disclosure. FIG. 7 is a circuitry diagram illustrating the antenna unit and the capacitor unit in FIG. 6.

Referring to FIG. 6 and FIG. 7, an antenna unit 100 includes a first antenna pattern line 110 and a second antenna pattern line 120. A first region S₁ may be formed on the first pattern line 110. The first region S₁ may include first electrode 115 and second electrode 171. The second electrode 171 may be connected to connection member 191 and a switch 181 and the first electrode 115 may be connected to a power supply V. The first electrode 115 and second electrode 171 may be separated by a distance d₁. A second region S₂ may be formed on the second antenna pattern 120. The second region S₂ may include a first electrode 125 and a second electrode 172. The second electrode 172 may be connected to a connection unit 192 and a second switch 182 and the first electrode 125 may be connected to power supply V. The first electrode 125 and the second electrode 172 may be separated by a distance d₂.

Referring to FIG. 6, the antenna unit 100 includes a main antenna. The main antenna may include a first antenna pattern line 110 and a second antenna pattern line 120. The main antenna may include the signal supply line 111 connected to a signal line, and a ground line 112 connected to a ground.

With respect to a wavelength λ₁ of the high frequency band and a wavelength λ₂ of the low frequency band, the resonance frequency of the high frequency band may be expressed as fₕ₁, and the resonance frequency of the low frequency band may be expressed as f_{L}.

The coupling ground line 130 to be used for multi resonance in the high frequency band may be included in the antenna unit 100. The resonance frequency of the high frequency band generated by the coupling ground line 130 may be represented by fₕ₂.

Referring to FIG. 6 and FIG. 7, a first capacitor unit C₁ and a second capacitor unit C₂ formed in the first region S₁ are included.

The first capacitor unit C₁ may include a second electrode 171 adjacent to a space from the ground point P₁ of the first antenna pattern line 110 which is the first region S₁ to a λ₁/4 point, and a first switch 181 for selectively connecting the second electrode 171 to a ground terminal. The second electrode 171 and the first switch 181 may be connected by a connection unit 191.

A through hole H₁ may be formed in the first region S₁ of the first antenna pattern line 110, and the first electrode 115 may be formed on the first antenna pattern line 110 by the electrical charge of the second electrode 171. The electrical charge of the second electrode 171 may influence the first antenna pattern line 110 via the through hole H₁.

The second electrode 171 may be formed in or substantially surrounded by the through hole H₁, and the first electrode 115 and the second electrode 171 may be disposed in the same plane.

Referring to FIG. 7, a first coupling capacitance C1 may be formed at the first capacitor unit C₁. The first capacitor unit C₁ may be formed of four sub-capacitors formed between a first electrode 115a and a second electrode 171a, a first electrode 115b and a second electrode 171b, a first electrode 115c and a second electrode 115c, a first electrode 115d and a second electrode 171d. Each electrode of each sub-capacitor may have an opposite area. The combined area of each electrode in the sub-capacitor may be referred to as an opposite area of a first electrode and a second electrode. The four sub-capacitors may be disposed on four sides surrounding the hole H₁. The four sub-capacitors may be connected in parallel and the first coupling capacitance C1 may be proportional to the sum of four sub-capacitance areas. Although illustrated and described as being four, aspects need not be limited thereto such that the first capacitor unit C1 may include more or fewer sub-capacitors, i.e., the hole H1 of 110 and the 171 may have other shapes, for example, the H1 and the 171 may be triangular, pentagonal, hexagonal, etc.

The first coupling capacitance C1 formed between the first electrode 115 and the second electrode 171 may be determined according to a voltage of the first region S₁ of the first electrode 115, a distance d₁ between the first electrode 115 and the second electrode 171, and a first opposite area between the first electrode 115 and the second electrode 171.

According to the voltage distribution of the first region S₁, the resonance frequency fₕ₁ may shift to resonance frequency fₕ₁′ in a high frequency band by the antenna unit 100, but the resonance frequency f_{L} of the low frequency band may be maintained. The first capacitor unit C1 does not influence the coupling ground line 130, and thus resonance frequency fₕ₂ may not shift even though the resonance frequency fₕ₁ of the high frequency band may shift to resonance frequency fₕ₁′.

The first coupling capacitance C1 may decrease as the distance d₁ between the first electrode 115 and the second electrode 171 increases, and the first coupling capacitance C1 of the first capacitor unit C₁ may be adjusted by adjusting the distance d₁.

The first opposite area of the first electrode 115 and the second electrode 171 may be determined by determining the area of the four sides of the second electrode 171 disposed towards the through hole H₁ and an area of a surface of the first electrode 115 opposite to the area of the four sides of the second electrode 171. Since the first coupling capacitance C1 increases as the first opposite area increases, the first coupling capacitance C1 may be controlled by adjusting the area of the four sides of the second electrode 171 and an area of the surface of the first electrode 115 opposite to the second electrode 171.

Referring to FIG. 6 and FIG. 7, the coupling ground line 130 may be disposed adjacent to the first region S₁. The second electrode 171, the antenna pattern line 110 of the first region S₁, and the coupling ground line 130 may be disposed in this order, but are not limited thereto.

The antenna pattern line 110 may be disposed between the second electrode 171 and the coupling ground line 130. The second electrode 171 may not influence the coupling ground line 130, and a coupling capacitance may not be formed at the coupling ground line 130 although the second electrode 171 is activated.

The second capacitor unit C₂ may include the second electrode 172 disposed adjacent to the second region S₂, and a second switch 182 to selectively connect the second electrode 172 to a ground terminal. The second electrode 172 and the second switch 182 may be connected to a connection unit 192.

A through hole H₂ may be formed in the second region S₂ of the second antenna pattern line 120, and a first electrode 125 may be formed on the second antenna pattern line 120 by the electrical charge of the second electrode 172. The electrical charge of the second electrode 172 may influence the second antenna pattern line 120 via the through hole H₂.

The second electrode 172 may be formed in or substantially surrounded by the through hole H₂, and the first electrode 125 and the second electrode 172 may be disposed in the same plane.

Referring to FIG. 7, the second coupling capacitance C2 may be formed by the second capacitor unit C₂. The second capacitor unit C₂ may be formed of four sub-capacitors formed between a first electrode 125a and a second electrode 172a, a first electrode 125b and a second electrode 172b, a first electrode 125c and a second electrode 172c, a first electrode 125d and a second electrode 172d. Each sub-capacitor may have an opposite area formed by the opposite areas of the four sub-capacitors. The four sub-capacitors may be connected in parallel, and the sum of the capacitances of the four sub-capacitors may be the second coupling capacitance C2 formed by the second capacitor unit C₂.

As described above with reference to the first capacitor unit C₁, the second coupling capacitance C2 of the second capacitor unit C₂ may be determined according to a voltage of the second region S₂ of the first electrode 125, the distance d₂ between the first electrode 125 and the second electrode 172, and a first opposite area of the first electrode 125 and the second electrode 172.

According to the voltage distribution of the second region S₂, the resonance frequency may shift from resonance frequency f_{L} to resonance frequency f_{L}′ in the low frequency band, but the resonance frequency fₕ₁ and the resonance frequency fₕ₂ of the high frequency band may be maintained.

The coupling capacitance C2 may decrease as the distance d₂ between the first electrode 125 and the second electrode 172 increases, and the second coupling capacitance C2 of the second capacitor unit C₂ may be controlled by adjusting the distance d₂.

The first opposite area of the first electrode 125 and the second electrode 172 may be determined by determining the area of the four sides of the second electrode 172 disposed toward the through hole H₂ and an area or a surface of the first electrode 125 opposite to the area of the four sides of the second electrode 172. Since the second coupling capacitance C2 increases as the first opposite area increases, the second coupling capacitance C2 may be controlled by adjusting the area of the four sides of the second electrode 172 and an area of the surface of the first electrode 125 opposite to the second electrode 172.

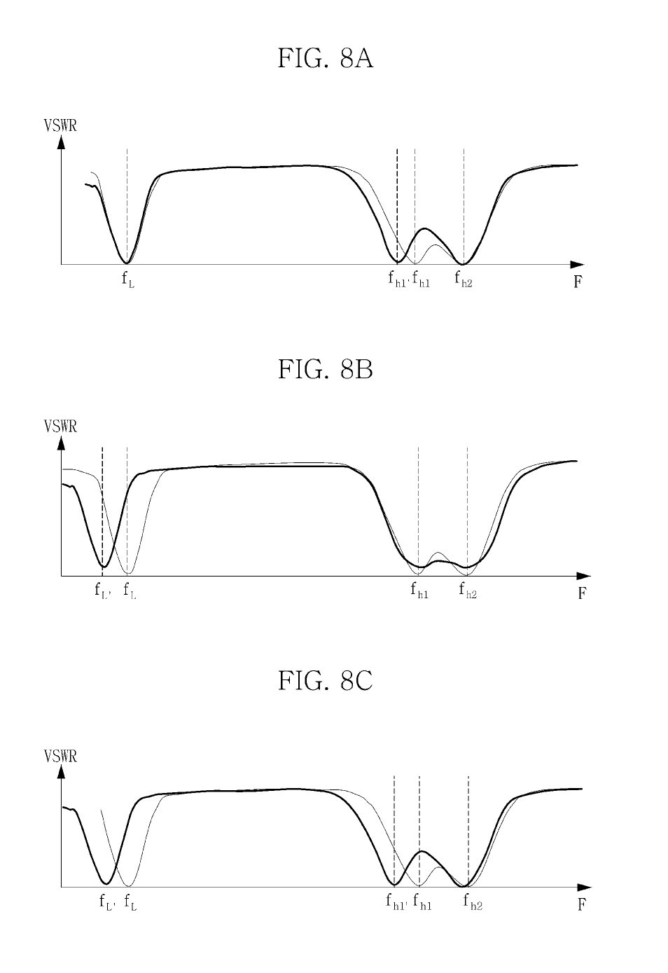

FIG. 8A, FIG. 8B and FIG. 8C are graphs illustrating standing wave ratios according to an exemplary embodiment of the present disclosure. FIG. 8A, FIG. 8B, and FIG. 8C illustrate standing waves according to an ON/OFF state of the first switch 181 and the second switch 182 of FIG. 6 and FIG. 7. Although described with reference to FIG. 6 and FIG. 7, the graphs of FIG. 8A, FIG. 8B, and FIG. 8C are not limited thereto.

Referring to FIGS. 6 and 7, if the first capacitor unit C₁ and the second capacitor unit C₂ are formed in the antenna unit 100, the frequency of the antenna unit 100 may shift as shown in Table 2 below according to whether the first capacitor unit C₁ and the second capacitor unit C₂ are activated.

TABLE 2

| | | Coupling | Resonance |
|---|---|---|---|
| | Band | capacitance | frequency |
| first switch OFF | high frequency band | — | fₕ₁ |
| second switch OFF | | — | fₕ₂ |
| | low frequency band | — | f_{L} |
| first switch ON | high frequency band | C1 | fₕ₁ → fₕ₁′ |
| second switch OFF | | — | fₕ₂ |
| (see FIG. 8A) | low frequency band | →0 | f_{L} |
| first switch OFF | high frequency band | — | fₕ₁ |
| second switch ON | | — | fₕ₂ |
| (see FIG. 8B) | low frequency band | C2 | f_{L} → f_{L}′ |
| first switch ON | high frequency band | C1 | fₕ₁ → fₕ₁′ |
| second switch ON | | — | fₕ₂ |
| (see FIG. 8C) | low frequency band | C2 | f_{L} → f_{L}′ |

Referring to FIG. 8A, FIG. 8B, FIG. 8C, and Table 2, if the first capacitor unit C₁ is activated or in an ON state, the resonance frequency fₕ₁ of the high frequency band of the antenna unit 100 may shift to the resonance frequency fₕ₁′, and the remaining resonance frequencies, i.e., a resonance frequency fₕ₂ and the resonance frequency f_{L}, may not shift. If the second capacitor unit C₂ is activated or in an ON state, a resonance frequency f_{L} of the low frequency band may shift to the resonance frequency f_{L}′, and remaining frequencies, i.e., the resonance frequency fₕ₁ and the resonance frequency fₕ₂, may not shift. If the first capacitor unit C₁ and second capacitor unit C₂ are activated, the resonance frequency fₕ₁ of the high frequency band may shift to the resonance frequency fₕ₁′, and the resonance frequency f_{L} of the low frequency band may shift to the resonance frequency f_{L}′.

According to exemplary embodiments, a selected resonance frequency may shift without changing the length of the first antenna pattern line 110 and second antenna pattern line 120 of the antenna unit 100. Therefore, a mobile communication device including the antenna unit 100 may have an improved matching characteristic or an improved standing characteristic may be provided by the antenna unit 100.

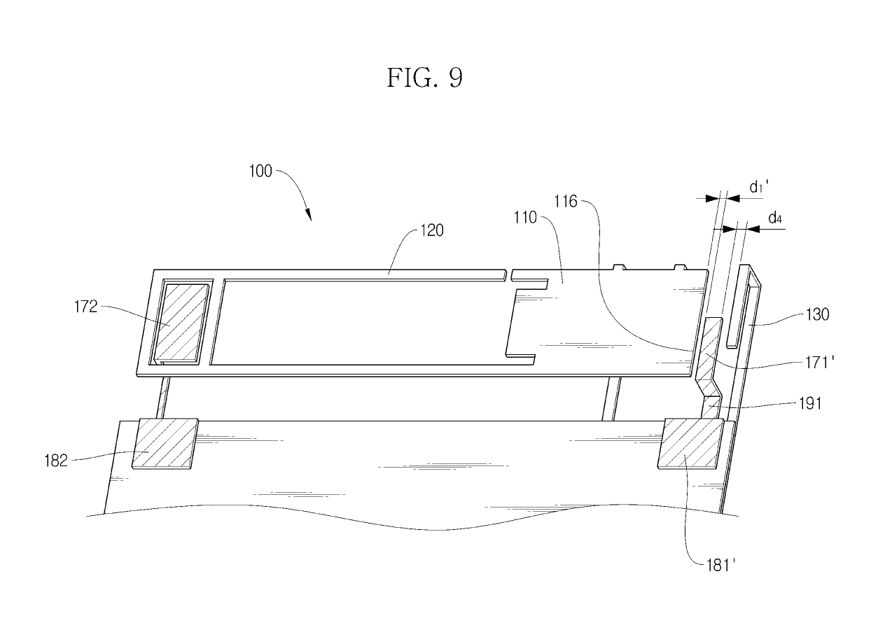

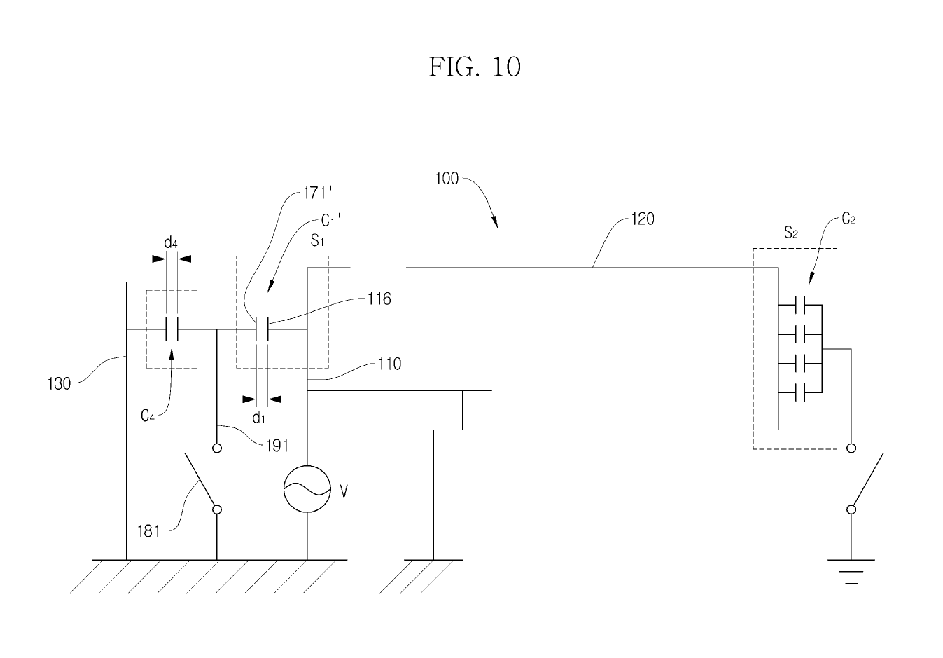

FIG. 9 is a perspective view illustrating an antenna unit and a capacitor unit according to an exemplary embodiment of the present disclosure. FIG. 10 is a circuitry diagram illustrating an antenna unit and a capacitor unit of FIG. 9.

Referring to FIG. 9 and FIG. 10, an antenna unit 100 includes a first antenna pattern line 110 and a second antenna pattern line 120. A first region S₁ may be partially formed on the first pattern line 110. The first region S₁ may include first electrode 116 and second electrode 171′. The second electrode 171′ may be connected to connection member 191 and a switch 181′ and the first electrode 116 may be connected to a power supply V. The first electrode 116 and second electrode 171′ may be separated by a distance d₁′. A fourth capacitor unit C₄ may be formed on a coupling ground line 130 adjacent to the first region S₁. A second region S₂ may be formed on the second antenna pattern 120. The second region S₂ may include a first electrode and a second electrode 172. The second region S₂ may be similar to the second region S₂ of FIG. 6 and FIG. 7, and therefore descriptions thereof may be omitted for brevity.

The first capacitor unit C₁′ may include the second electrode 171′ disposed in the first region S₁, and a first switch 181′ disposed adjacent to the first region S₁ to selectively connect the second electrode 171′ to a ground terminal. The second electrode 171′ and the first switch 181′ may be connected to a connection unit 191.

The second electrode 171′ may be disposed adjacent to the first antenna pattern line 110. Accordingly, a portion of the first antenna pattern line 110 adjacent to and opposite to the second electrode 171′ may become the first electrode 116.

Referring to FIG. 10, the coupling capacitance C1′ may be formed by the first capacitor unit C₁′ including the first electrode 116 and the second electrode 171′, the coupling capacitance C1′ may be determined by a voltage of the first region S₁ of the first electrode 116, the distance d₁′ between the first electrode 116 and the second electrode 171′, and a first opposite area of the first electrode 116 and the second electrode 171′.

In the voltage distribution of the first region S₁, the resonance frequency fₕ₁ shifts to the resonance frequency fₕ₁′ in a high frequency band of the antenna unit 100, and the resonance frequency f_{L} of the low frequency band is maintained.

Referring to FIG. 9, the coupling ground line 130 may be disposed adjacent to the first region S₁. The first electrode 116 may be disposed directly adjacent to the second electrode 171′ and the second electrode 171′ may be disposed directly adjacent to the coupling ground line 130, but are not limited thereto.

If the second electrode 171′ is charged, because the charge on the second electrode 171′ influences the first electrode 116 and the coupling ground line 130, a first coupling capacitance C1′ may be formed between the first electrode 116 and the second electrode 171′, and a fourth coupling capacitance C4 may be formed between the coupling ground line 130 and the second electrode 171′, separated by distance d₄.

The frequency emitted from the coupling ground line 130 may correspond to a wavelength of a high frequency band, similar to the resonance frequency fₕ₁, and a resonance frequency fₕ₂ in the high frequency band may shift to a resonance frequency fₕ₂′ because of the formation of the fourth coupling capacitance C4 on the coupling ground line 130.

The first coupling capacitance C1′ may decrease as the distance d₁′ between the first electrode 116 and the second electrode 171′ increases, and the first coupling capacitance C1′ formed by the first capacitor unit C₁′ may be controlled by adjusting the distance d₁′.

The fourth coupling capacitance C4 may be controlled by adjusting the distance d₄′ between the second electrode 171′ and the coupling ground line 130.

The first coupling capacitance C1′ may increase as a first opposite area of the first electrode 116 and the second electrode 171′ increases. The first coupling capacitance C1′ may be controlled by adjusting the first opposite area of the second electrode 171′ and the first electrode 116. The fourth coupling capacitance C4 may be controlled by adjusting a fourth opposite area of the second electrode 171′ and the coupling ground line 130.

The second capacitor unit C₂ may be similar to the second capacitor unit C₂ of FIG. 6 and FIG. 7, and the second capacitor unit C₂ may allow a resonance frequency in a low frequency band to shift from resonance frequency f_{L} to resonance frequency f_{L}′, while allowing the resonance frequency fₕ₁ and the resonance frequency fₕ₂ of a high frequency band to be maintained.

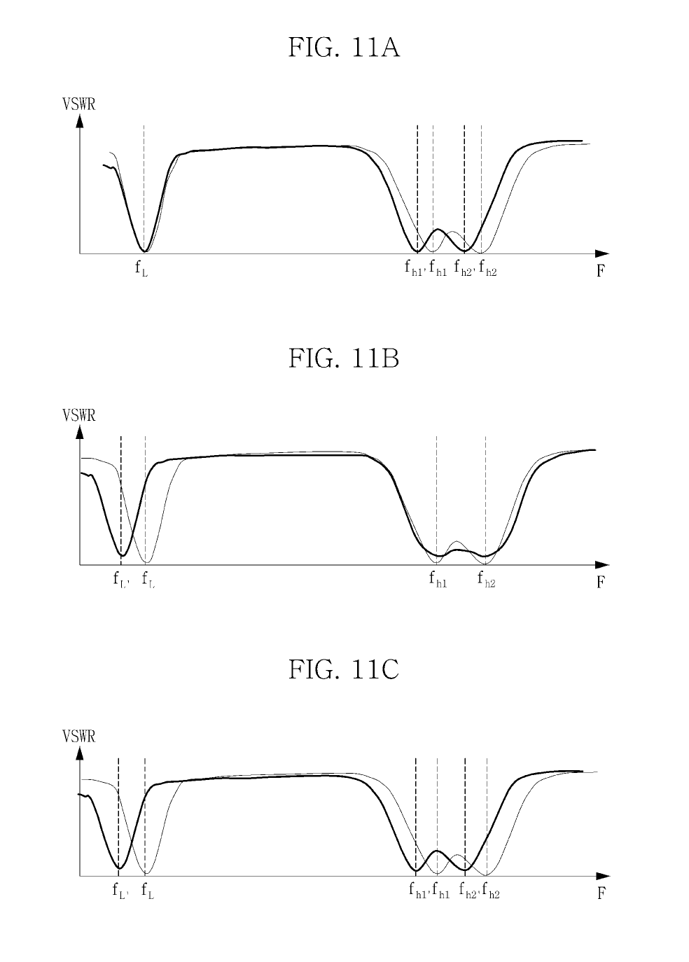

FIG. 11A, FIG. 11B and FIG. 11C are graphs illustrating standing wave ratios according to an exemplary embodiment of the present disclosure. FIG. 11A, FIG. 11B and FIG. 11C illustrate standing waves according to an ON/OFF state of the first switch 181′ and the second switch 182 of FIG. 9 and FIG. 10. Although described with reference to FIG. 9 and FIG. 10, the graphs of FIG. 11A, FIG. 11B, and FIG. 11C are not limited thereto.

Referring to FIG. 9 and FIG. 10, if the first capacitor unit C₁′ and the second capacitor unit C₂ are formed in the antenna unit 100, the frequency of the antenna unit 100 may shift as shown in Table 3 below according to whether the first capacitor unit C1′ and the second capacitor unit C₂ are activated.

TABLE 3

| | | | Resonance |
|---|---|---|---|
| | Band | Coupling capacitance | frequency |
| first switch OFF | high frequency | — | fₕ₁ |
| second switch OFF | band | — | fₕ₂ |
| | low frequency | — | f_{L} |
| | band | | |
| first switch ON | high frequency | C1′ | fₕ₁ → fₕ₁′ |
| second switch OFF | band | C4 | fₕ₂ → fₕ₂′ |
| (see FIG. 11A) | low frequency | →0 | f_{L} |
| | band | | |
| first switch OFF | high frequency | — | fₕ₁ |
| second switch ON | band | — | fₕ₂ |
| (see FIG. 11B) | low frequency | C2 | f_{L} → f_{L}′ |
| | band | | |
| first switch ON | high frequency | C1′ | fₕ₁ → fₕ₁′ |
| second switch ON | band | C4 | fₕ₂ → fₕ₂′ |
| (see FIG. 11C) | low frequency | C2 | f_{L} → f_{L}′ |
| | band | | |

Referring to FIG. 11A, FIG. 11B, FIG. 11C, and Table 3, if the first capacitor unit C₁′ is activated, the resonance frequency fₕ₁ and the resonance frequency fₕ₂ of the high frequency band of the antenna unit shifts to the resonance frequency fₕ₁′ and the resonance frequency fₕ₂′, respectively, and the resonance frequency f_{L} of the low frequency band does not shift. If the second capacitor unit C₂ is activated, the resonance frequency f_{L} of the low frequency band shifts to the resonance frequency f_{L}′, and the remaining resonance frequencies, i.e., the resonance frequency fₕ₁ and the resonance frequency fₕ₂ do not shift. If the first capacitor unit C₁′ and second capacitor unit C₂ are activated, the resonance frequency fₕ₁ and the resonance frequency fₕ₂ of the high frequency band shift to the resonance frequency fₕ₁′ and the to resonance frequency fₕ₂′, respectively, and the resonance frequency f_{L} of the low frequency band shifts to the resonance frequency f_{L}′.

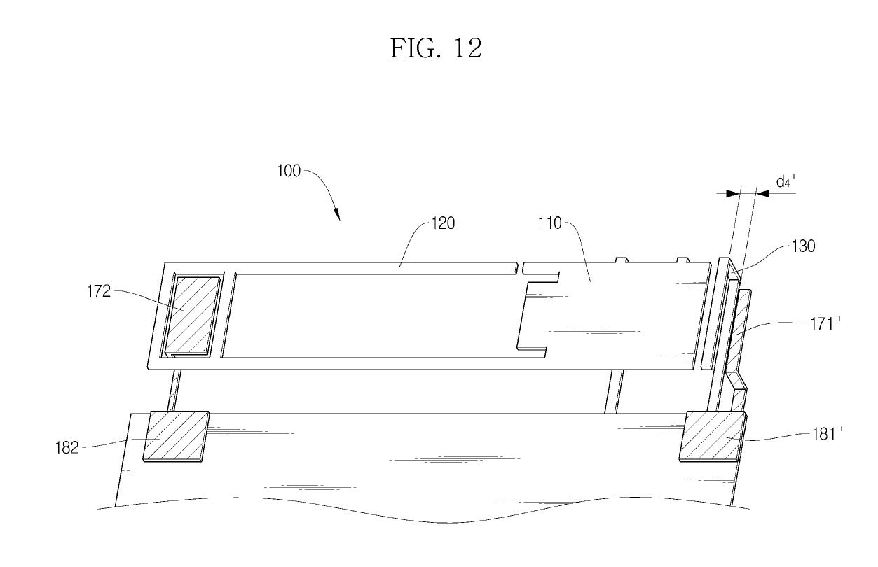

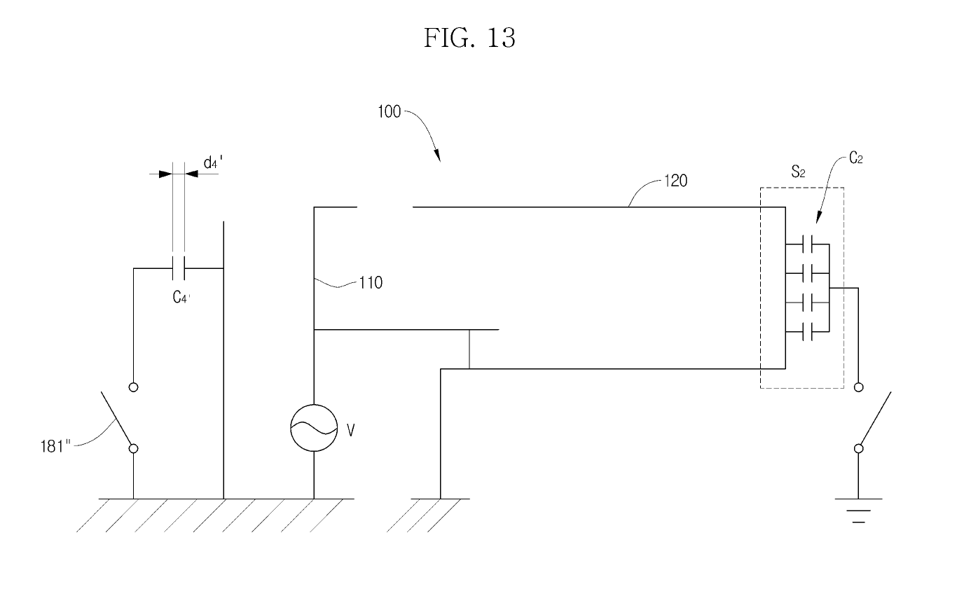

FIG. 12 is a perspective view illustrating an antenna unit and a capacitor unit according to an exemplary embodiment of the present disclosure. FIG. 13 is a circuitry diagram illustrating the antenna unit and the capacitor unit of FIG. 12.

Referring to FIG. 12 and FIG. 13, an antenna unit 100 includes a first antenna pattern line 110 and a second antenna pattern line 120. A coupling ground line 130 may be disposed adjacent to the first antenna pattern line 110. A second electrode 171″ may be disposed adjacent to the coupling ground line 130 and may be connected to a switch 181″. The second electrode 171″ may be separated by a distance d₄′ from a coupling ground line 130. A fourth capacitor unit C₄ may be formed between the coupling ground line 130 and the second electrode 171″. A second region S₂ may be formed on the second antenna pattern 120. The second region S₂ may include a first electrode and a second electrode 172 and may be similar to the second region of FIG. 6 and FIG. 7, and therefore descriptions thereof may be omitted for brevity.

A fourth capacitor unit may include the second electrode 171″ disposed adjacent to the first region S₁, and the first switch 181″ to selectively connect the second electrode 171″ to a ground terminal.

Referring to FIG. 12, the coupling ground line 130 may be disposed adjacent to the first region S₁. The first antenna pattern line 110 may be disposed directly adjacent to the coupling ground line 130, and the coupling ground line 130 may be disposed directly adjacent to the second electrode 171″, but are not limited thereto.

The coupling ground line 130 may be disposed between the first antenna pattern line 110 and the second electrode 171″. The charge on the second electrode 171″ may not influence the first antenna pattern line 110. Therefore, a first coupling capacitance similar to the first coupling capacitance C1 and the first coupling capacitance C1′ of FIG. 7 and FIG. 10, respectively, is not formed in the antenna unit 100 of FIG. 12 and FIG. 13. In the antenna device of FIG. 12 and FIG. 13, the fourth coupling capacitance C4′ is formed at the coupling ground line 130.

The fourth coupling capacitance C4′ may vary according to the voltage distribution in the first region S₁, the distance between the second electrode 171″ and the coupling ground line 130 and the opposite area of the second electrode 171″ and the coupling ground line 130.

The resonance frequency of the coupling ground line 130 may correspond to a wavelength of a high frequency band. The coupling ground line 130 may be disposed adjacent to the first region, and the resonance frequency fₕ₂ of the coupling ground line 130 may shift to the resonance frequency fₕ₂′ according to the fourth coupling capacitance C4′.

The fourth coupling capacitance C4′ may be adjusted by adjusting the distance d₄′ between the second electrode 171″ and the coupling ground line 130. The fourth coupling capacitance C4′ may be adjusted by adjusting the opposite area of the second electrode 171″ and the coupling ground line 130.

The second capacitor unit C₂ may be disposed in the second region S₂, and may be substantially similar to the second capacitor unit C₂ of FIG. 6 and FIG. 7. The second capacitor unit C₂ may allow the resonance frequency of the low frequency band to shift from a resonance frequency f_{L} to a resonance frequency f_{L}′ and allow the resonance frequency fₕ₁ and the resonance frequency fₕ₂ of the high frequency band to be maintained.

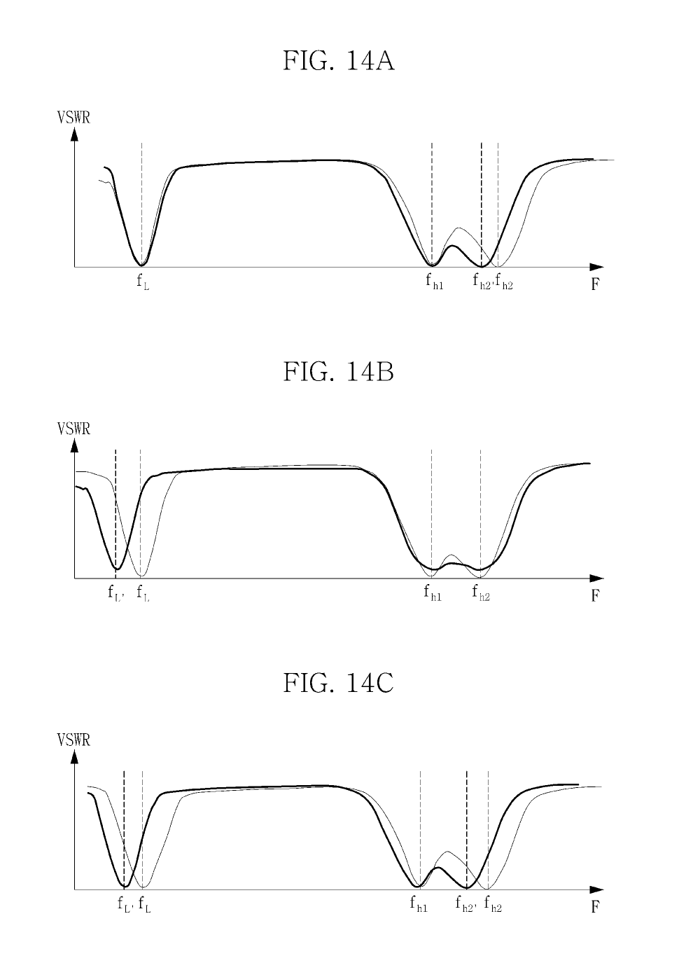

FIG. 14A, FIG. 14B, and FIG. 14C are graphs illustrating standing wave ratios according to an exemplary embodiment of the present disclosure. FIG. 14A, FIG. 14B, and FIG. 14C illustrate standing waves according to an ON/OFF state of a first switch 181″ and a second switch 182 of FIG. 12 and FIG. 13. Although described with reference to FIG. 12 and FIG. 13, the graphs of FIG. 14A, FIG. 14B, and FIG. 14C are not limited thereto.

If, the fourth capacitor unit and the second capacitor unit C₂ are formed, the frequency of the antenna unit 100 may shift as shown in Table 4 below according to whether the fourth capacitor unit and the second capacitor unit C₂ are activated.

TABLE 4

| | | Coupling | Resonance |
|---|---|---|---|
| | Band | capacitance | frequency |
| first switch OFF | high frequency band | — | fₕ₁ |
| second switch OFF | | — | fₕ₂ |
| | low frequency band | — | f_{L} |
| first switch ON | high frequency band | — | fₕ₁ |
| second switch OFF | | C4′ | fₕ₂ → fₕ₂′ |
| (see FIG. 14A) | low frequency band | →0 | f_{L} |
| first switch OFF | high frequency band | — | fₕ₁ |
| second switch ON | | — | fₕ₂ |
| (see FIG., 14B) | low frequency band | C2 | f_{L} → f_{L}′ |
| first switch ON | high frequency band | — | fₕ₁ |
| second switch ON | | C4 | fₕ₂ → fₕ₂′ |
| (see FIG. 14C) | low frequency band | C2 | f_{L} → f_{L}′ |

Referring to FIG. 14A, FIG. 14B, FIG. 14C, and Table 4, if the fourth capacitor unit is activated, the resonance frequency fₕ₂ of the high frequency band of the antenna unit may shift to the resonance frequency fₕ₂′, and the resonance frequency fₕ₁ of the high frequency band of the antenna unit and the resonance frequency f_{L} of the low frequency band may not shift. If the second capacitor unit C₂ is activated, the resonance frequency f_{L} of the low frequency band may shift to the resonance frequency f_{L}′, and remaining frequencies, the resonance frequency fₕ₁ and the resonance frequency fₕ₂ may not shift. If the fourth capacitor unit and second capacitor unit C₂ are activated, the resonance frequency fₕ₂ of the high frequency band may shift to the frequency fₕ₂′ and the frequency f_{L} of the low frequency band may shift to the resonance frequency f_{L}′, but the resonance frequency fₕ₁ of the high frequency band may not shift.

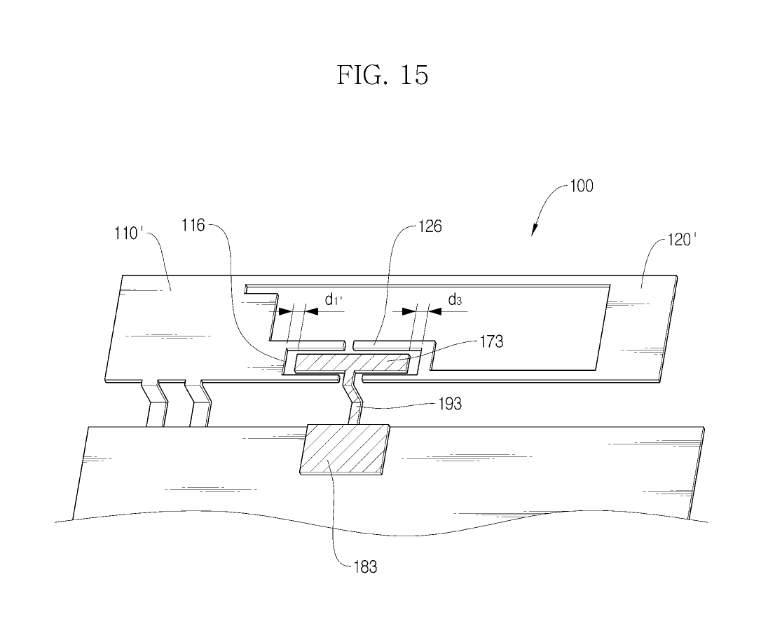

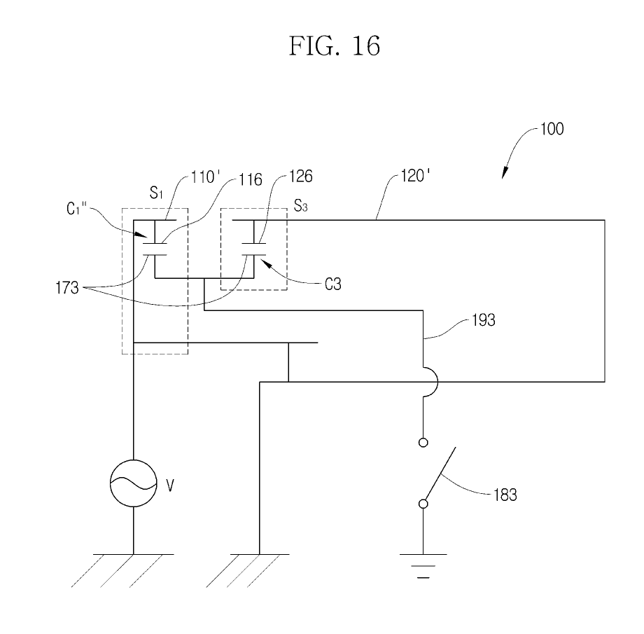

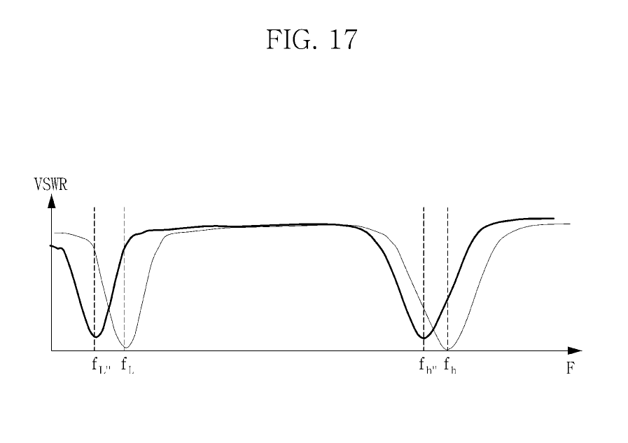

FIG. 15 is a perspective view illustrating an antenna unit and a capacitor unit according to an exemplary embodiment of the present disclosure. FIG. 16 is a circuitry diagram illustrating the antenna unit and the capacitor unit of FIG. 15. Referring to FIG. 15 and FIG. 16, an antenna unit 100 includes a first antenna pattern line 110′ and a second antenna pattern line 120′, and a first capacitor unit C₁″ disposed in a first region S₁ and a third capacitor unit C₃ disposed in a third region S₃.

Referring to FIG. 15 and FIG. 16, an antenna unit 100 includes a first antenna pattern line 110′ and a second antenna pattern line 120′. A first region S₁ may be formed on the first pattern line 110′. The first region S₁ may include first electrode 116 and second electrode 173. The second electrode 173 may be connected to a connection member 193 and a switch 183 and the first electrode 116 may be connected to a power supply V. The first electrode 116 and second electrode 171 may be separated by a distance d₁. A third region S₃ may be formed on the second antenna pattern 120′. The second region S₂ may include a first electrode 1265 and the second electrode 173. The first electrode 126 may be connected to power supply V. The first electrode 126 and the second electrode 173 may be separated by a distance d₃.

The second electrode 173 may be disposed adjacent to at least one of the first region S₁, the second region S₂, and the third region S₃ simultaneously. Referring to FIG. 15 and FIG. 16, the second electrode 173 may be formed adjacent to the first region S₁ and the third region S₃ simultaneously.

The first capacitor unit C₁″ may include a second electrode 173 disposed adjacent to the first region S₁, and a first switch 183 to selectively connect the second electrode 173 to a ground terminal.

The resonance frequency fₕ of the high frequency band may be shifted by the first capacitor unit C₁″, and the resonance frequency f_{L} of the low frequency band may be maintained.

The first capacitance C1″ formed by the first capacitor unit C₁″ may be adjusted according to the voltage distribution on the first electrode 116 of the first region S₁ disposed to be opposite to the second electrode 173, the distance d₁″ between the first electrode 116 and the second electrode 173, and the opposite area of the first electrode 116 and the second electrode 173.

The third capacitor unit C₃ may be formed by inducing a coupling capacitance as the second electrode 173. The second electrode 173 may be disposed to be opposite to the third region S₃ of the second antenna pattern line 120′ and may therefore induce a charge to build on the first electrode 126 and a capacitance to form between the first electrode 126 and the second electrode 173.

The second electrode 173 may be activated in the first region S₁ and the third region S₃ if the first switch 183 is connected, thereby forming the first coupling capacitance C1″ and the third coupling capacitance C3.

The third coupling capacitance C3 may be determined according to the voltage distribution of a first electrode 126 of the third region S₃ opposite to the second electrode 173, the distance d₃ between the first electrode 126 and the second electrode 173 and the opposite area of the first electrode 126 and the second electrode 173.

The third capacitor unit C₃ may allow both a resonance frequency fₕ of the high frequency band and a resonance frequency f_{L} of the low frequency band to shift, as described with reference to Table 1, because the third region S₃ is formed.

If the first switch 183 is connected, both the resonance frequency fₕ and the resonance frequency f_{L} may shift by the first coupling capacitance C1″ and the third coupling capacitance C3.

FIG. 17 is a graph illustrating a standing wave ratio according to an exemplary embodiment of the present disclosure. FIG. 17 illustrates standing waves according to an ON/OFF state of the first switch 183 of FIG. 15 and FIG. 16. Although described with reference to FIG. 15 and FIG. 16, the graph of FIG. 17 is not limited thereto.

Referring to FIG. 17, if the first capacitor unit C₁″ and the third capacitor unit C₃ are formed in the antenna unit 100, the resonance frequency of the antenna unit 100 may shift as shown in Table 5 below according to whether the first capacitor unit C₁″ and the third capacitor unit C₃ are activated.

TABLE 5

| | | | Resonance |
|---|---|---|---|
| | Band | Coupling capacitance | frequency |
| first switch | high frequency | — | fₕ |
| OFF | band | | |
| | low frequency | — | f_{L} |
| | band | | |
| first switch | high frequency | C1, C31 | fₕ → fₕ″ |
| ON | band | | |
| (see FIG. 17) | low frequency | C32 | f_{L} → f_{L}″ |
| | band | | |

Referring to FIG. 17 and Table 5, if the first switch 183 is activated, both the resonance frequency fₕ of the high frequency band and the resonance frequency f_{L} of the low frequency band shift to the resonance frequency fₕ″ and the resonance frequency f_{L}″, respectively.

The resonance frequencies of the high frequency band and the low frequency band may shift by using a single switch.

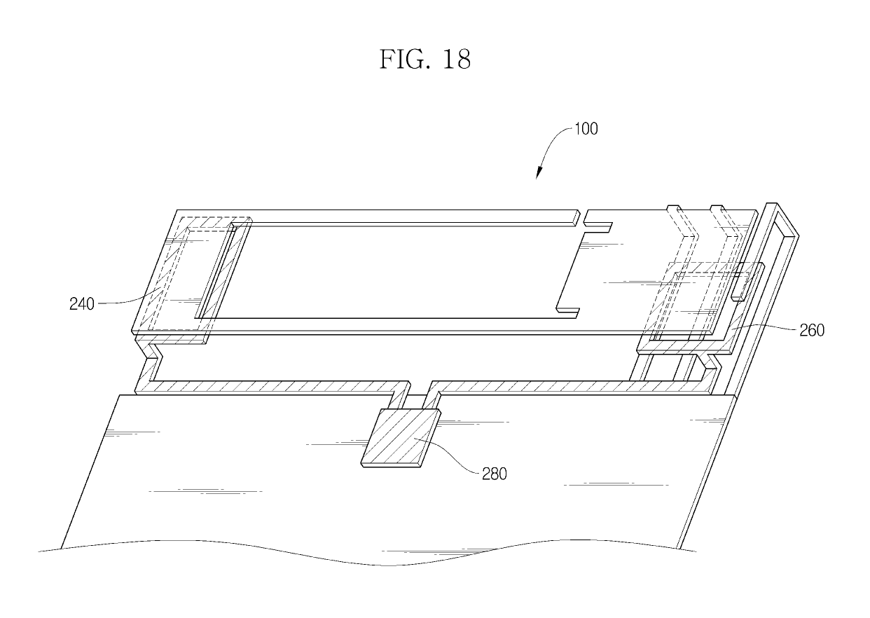

FIG. 18 is a perspective view illustrating an antenna unit and a capacitor unit according to an exemplary embodiment of the present disclosure. FIG. 18 may be similar to FIG. 6, FIG. 7, and FIG. 8 and descriptions of similar features will be omitted for brevity.

Referring to FIG. 18, in an antenna unit 100, a first capacitor unit may be formed by a first electrode and a second electrode 240. The first electrode of the first capacitor unit may be a portion of an antenna pattern line disposed opposite to the second electrode 240. A second capacitor unit may be formed by a first electrode and a second electrode 260. The first electrode of the second capacitor unit may be a portion of the antenna pattern line disposed opposite to the second electrode 260. A switch 280 may be connected to the second electrode 240 and the second electrode 260.

The first electrode and the second electrode 240 may be disposed on the same plane or parallel to each other. The second electrode 240 may have a ring shape or a plate shape, but is not limited thereto. The first electrode may be formed in the antenna pattern line 110. The first electrode and the second electrode 260 may be disposed on the same plane or parallel to each other. The second electrode 260 may have a ring shape or a plate shape, but is not limited thereto. The first electrode may have any shape.

The second electrode 240 and the second electrode 260 may have a ring shape and may be disposed parallel to the antenna pattern line.

A first coupling capacitance of the first capacitor unit may be determined according to a voltage distribution of the first electrode disposed on the antenna pattern line parallel to and opposite to the second electrode 240, the distance between the second electrode 240 and the antenna pattern line, and the opposite area of the second electrode 240 and the first electrode disposed on the antenna pattern opposite to the second electrode 240. A second coupling capacitance of the second capacitor unit may be determined according to a voltage distribution of the first electrode disposed on the antenna pattern line parallel to and opposite to the second electrode 260, the distance between the second electrode 260 and the antenna pattern line, and the opposite area of the second electrode 260 and the first electrode disposed on the antenna pattern opposite to the second electrode 260.

The first capacitor unit and the second capacitor unit may be connected to the switch 280. The resonance frequencies of the high frequency band and the low frequency band of the antenna unit of FIG. 18 may shift by the operation of the switch 280.

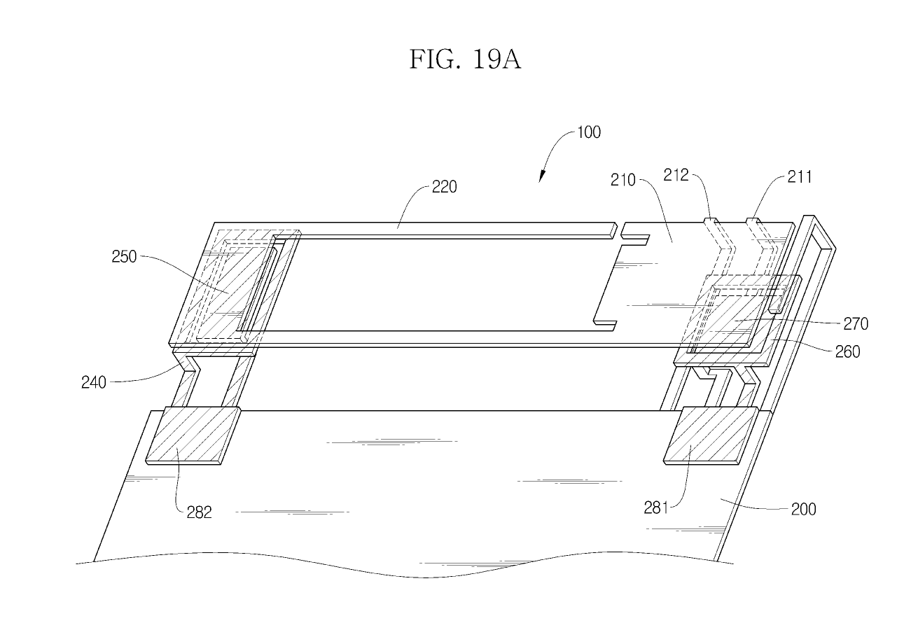

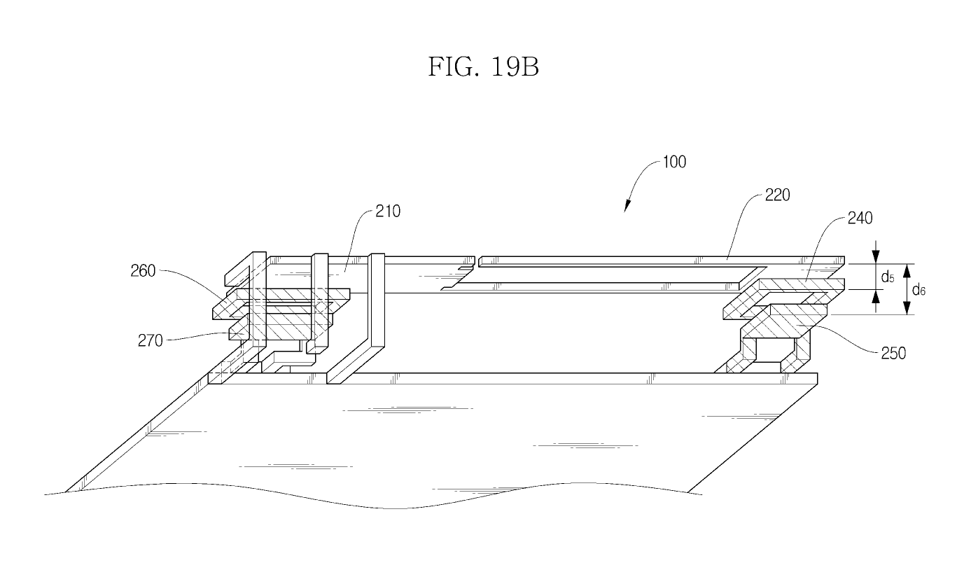

FIG. 19A is a perspective view illustrating an antenna unit and a capacitor unit according to an exemplary embodiment of the present disclosure. FIG. 19B is a rear view illustrating the antenna unit and the capacitor unit of FIG. 19A.

Referring to FIG. 19A and FIG. 19B, in an antenna unit 100, a first capacitor unit may be formed by a first electrode, a second electrode 240, and a third electrode 250. The first electrode of the first capacitor unit may be a portion of a second antenna pattern line 220 disposed opposite to the second electrode 240 and the third electrode 250. A first switch 282 may be connected to the second electrode 240 and the third electrode 250. A second capacitor unit may be formed by a first electrode, a second electrode 260, and a third electrode 270. The first electrode of the second capacitor unit may be a portion of a second antenna pattern line 220 disposed opposite to the second electrode 260 and the third electrode 270. A second switch 281 may be connected to the second electrode 260 and the third electrode 270.

Referring to FIG. 19A and FIG. 19B, at least two opposite electrodes arranged in the same region and having an opposite area may be included in an antenna unit 100.

The first capacitor unit may include at least two opposite electrodes. The first capacitor unit may include a second electrode and a third electrode. The opposite electrodes may be a ring shaped second electrode 240 and a flat plate shaped third electrode 250. The ring shaped second electrode 240 and the flat plate shaped third electrode 250 may be disposed parallel to the first antenna pattern line 210 to be opposite to the same region of the first antenna pattern line 210. The second electrode 240 and the third electrode 250 may be connected to a ground terminal by the first switch 282.

Although the second electrode 240 may be a ring shaped second electrode and the third electrode 250 may be a flat plate shaped third electrode, the present disclosure is not limited thereto. For example, and the second electrode 240 may be flat plate shaped and the third electrode 250 may be ring shaped. Further, the ring shaped second electrode 240 may have a square ring, circular ring, elliptical ring, or other ring shape.

The first switch 282 may selectively connect the second electrode 240 and the third electrode 250. The first switch 282 may connect both the second electrode 240 and the third electrode 250 to a ground terminal. The first switch 282 may be connected to the second electrode 240 and the third electrode 250 by a digital circuit.

The second electrode 240 and the third electrode 250 may be connected to the ground terminal to form a first coupling capacitance. The first coupling capacitance may be determined according to the voltage distribution of the first electrode, which may be a region of the second antenna pattern line 220 opposite to the second electrode 240 and the third electrode 250, a distance d₅ between the first electrode disposed on the second antenna pattern line 220 and the second electrode 240 or a distance d₆ between the first electrode and the third electrode 250, and a first opposite area and a second opposite area in which the ring shape second electrode 240 and the flat plate shape third electrode 250 are, respectively, opposite to the first electrode.

The first opposite area of the second electrode 240 and the first electrode and the second opposite area of the third electrode 250 and the first electrode may be disposed to be parallel to each other. The first opposite area of the second electrode 240 and the first electrode and the second opposite area of the third electrode 250 and the first electrode may be determined according to the areas of the second electrode 240 and the third electrode 260, respectively, because the antenna pattern line has a relatively large size.

The second electrode 240 and the third electrode 250 may have different areas and may be spaced apart from the first electrode by distance d₅ and distance d₆, respectively. The distance d₅ and d₆ may differ from each other. The second electrode 240 and the third electrode 250 may have different coupling capacitance values.

The first coupling capacitance may change in value depending on which opposite electrode between the second electrode 240 and the third electrode 240 is connected to a ground terminal.

The second capacitor unit may include a ring shaped second electrode 260 and a flat plate shaped third electrode 270. The second electrode 260 and the third electrode 270 may be connected to a second switch 281. Further, the ring shaped second electrode 260 may have a square ring, circular ring, elliptical ring, or other ring shape. Although the second electrode 260 may be ring shaped and the third electrode 270 may be flat plate shaped, the present disclosure is not limited thereto. For example, and the second electrode 260 may be flat plate shaped and the third electrode 270 may be ring shaped.

The second coupling capacitance may be determined according to the voltage distribution of the first electrode, which may be a region of the first antenna pattern line 210 opposite to the second electrode 260 and the third electrode 270, the distance between the first electrode and the second electrode 260 or the distance between the first electrode and the third electrode 270, and a first opposite area and a second opposite area in which the ring shape second electrode 260 and the flat plate shape third electrode 270 are, respectively, opposite to the first electrode. The second coupling capacitance may be determined based on whether the opposite electrode between the second electrode 260 and the third electrode 250 is connected.

According to the exemplary embodiments, the location and shape of the second electrode in an antenna unit may be controlled in various ways to adjust a coupling capacitance value, and the coupling capacitance value may be controlled to adjust the resonance frequency of the antenna unit.

According to the exemplary embodiment of the present disclosure, the second electrode may be made of materials with conductivity or high dielectric permittivity. A material with high dielectric permittivity may induce a greater coupling capacitance.

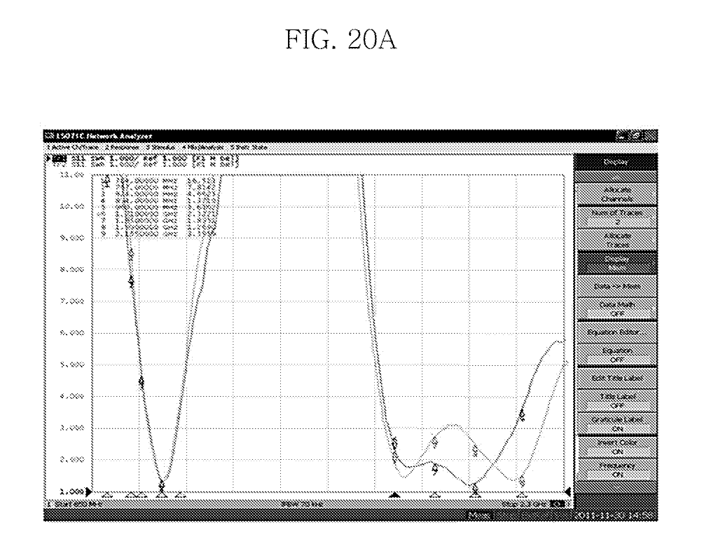

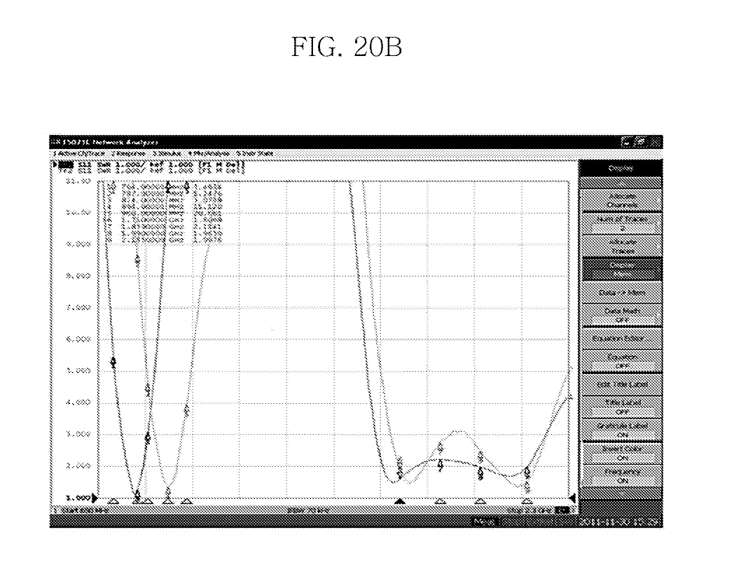

FIG. 20A and FIG. 20B are graphs illustrating matching characteristics of an antenna unit according to an exemplary embodiment of the present disclosure.

FIG. 20A is a graph illustrating a standing wave ratio if the first capacitor unit is in an activated state and in an inactivated state. FIG. 20B is a graph illustrating a standing wave ratio if the second capacitor unit is in an activated state and in an inactivated state.

Referring to FIG. 20A and FIG. 20B, both the standing wave ratios before and after frequency shifting in the high frequency band and the low frequency band have a value close to 1. In other words, because the resonance frequency shifts by forming a coupling capacitance while maintaining the length of the antenna pattern line without guiding frequency shifting by extending the antenna pattern line, the antenna unit may have improved matching characteristic and improved emission efficiency may be obtained in both the first region and the second region.

According to the exemplary embodiment, a resonance frequency may shift selectively by utilizing a capacitor unit. Because the capacitor unit is not connected to the antenna pattern line, an antenna module may have improved matching characteristic and improved emission characteristics may be implemented.

Even though a frequency band other than the band selected by a switch may cause a change of an electric length of an antenna and may deteriorate the entire characteristics in the related art, the length of the antenna element of the present disclosure does not change since the selective coupling capacitor is not directly connected to the antenna. Therefore, it may be possible to reduce electric characteristics from deteriorating due to the length change of the antenna.

In addition, because the exemplary embodiments do not use a structure which uses parasitic resonance according to a change of a length of the antenna pattern, it is possible to reduce the emission efficiency from rapidly deteriorating at a resonance frequency of a main antenna due to the interference of the parasitic resonance frequency.

Moreover, because the power source of the switch is not electrically connected to the antenna, noise may not be generated even though a switch is added to the antenna unit.

Since the coupling capacitor of the exemplary embodiments may be applied adjacent to the antenna pattern, the coupling capacitor may be applied to various products in a simple way, and may be applicable not only to multi-band antennas but also to single-band antennas.

It will be apparent to those skilled in the art that various modifications and variation can be made in the present invention without departing from the spirit or scope of the invention. Thus, it is intended that the present invention cover the modifications and variations of this invention provided they come within the scope of the appended claims and their equivalents.

What is claimed is:

1. A mobile terminal including an antenna, comprising:
a first antenna pattern line with a first length determined according to a first frequency to be received or transmitted by the first antenna pattern line;
a first capacitor unit having a first electrode disposed on the first antenna pattern line and a second electrode disposed opposite the first electrode; and
a first switch to selectively connect the second electrode to a ground to shift a resonant frequency of the first antenna pattern.

2. The mobile terminal of claim 1, further comprising:
a second antenna pattern line with a second length determined according to a second frequency to be received or transmitted by the second antenna pattern line;
a second capacitor unit having a third electrode disposed on the second antenna pattern line and a fourth electrode disposed opposite the third electrode; and
a second switch to selectively connect the fourth electrode to the ground.

3. The mobile terminal of claim 1, further comprising:
a second antenna pattern line with a second length determined according to a second frequency to be received or transmitted by the second antenna pattern line;
a second capacitor unit having a third electrode disposed on the second antenna pattern line and a fourth electrode disposed opposite the third electrode;
a second switch to selectively connect the fourth electrode to the ground; and
a coupling ground line, disposed adjacent to the first antenna pattern line, having a fifth electrode formed opposite to the second electrode.

4. The mobile terminal of claim 1, further comprising:
a second antenna pattern line with a second length determined according to a second frequency to be received or transmitted by the second antenna pattern line;
a second capacitor unit having a third electrode disposed on the second antenna pattern line disposed opposite the first electrode,
wherein the second capacitor unit is connected to the first capacitor unit and the first switch.

5. The mobile terminal of claim 1, further comprising:
a second capacitor unit disposed on the first antenna pattern line having a third electrode and a fourth electrode disposed opposite the third electrode,
wherein the second electrode and the fourth electrode are disposed parallel to the first antenna pattern line, and the second electrode and the fourth electrode are connected to the first switch.

6. The mobile terminal of claim 5, wherein the second electrode and the fourth electrode are ring shaped electrodes.

7. The mobile terminal of claim 1, further comprising:
a second antenna pattern line with a second length determined according to a second frequency to be received or transmitted by the second antenna pattern line;
a second capacitor unit having a third electrode disposed on a coupling ground line and a fourth electrode disposed opposite the third electrode; and
a second switch to selectively connect the fourth electrode to the ground.

8. The mobile terminal of claim 1, wherein the second electrode is disposed in a first hole in the first antenna pattern line.

9. The mobile terminal of claim 8, wherein the second electrode has four sides and the first capacitor unit includes four sub-capacitor units according to the four sides of the second electrode.

10. The mobile terminal of claim 1, wherein the fourth electrode is disposed in a first hole in the second antenna pattern line.

11. The mobile terminal of claim 10, wherein the fourth electrode has four sides and the second capacitor unit includes four sub-capacitor units according to the four sides of the fourth electrode.

12. The mobile terminal of claim 9, wherein the fourth electrode is disposed in a second hole in the second antenna pattern line.

13. The mobile terminal of claim 12, wherein the fourth electrode has four sides and the second capacitor unit includes four sub-capacitor units according to the four sides of the fourth electrode.

14. The mobile terminal of claim 1, further comprising:
a second antenna pattern line with a second length determined according to a second frequency to be received or transmitted by the second antenna pattern line;
a second capacitor unit having a fourth electrode disposed on the second antenna pattern line, a fifth electrode disposed opposite the fourth electrode, and a sixth electrode disposed opposite the fourth electrode; and
a second switch to connect the fifth electrode and the sixth electrode to the ground to shift a resonant frequency of the second antenna pattern line,
wherein the first capacitor unit further comprises a third electrode disposed opposite the first electrode and the first switch is disposed to connect the second electrode and the third electrode to the ground to shift a resonant frequency of the first antenna pattern.

15. The mobile terminal of claim 14, wherein the second electrode and third electrode are disposed parallel to the first electrode, and the fifth electrode and the sixth electrode are disposed parallel to the second electrode.

16. The mobile terminal of claim 15, wherein one of the second electrode and third electrode is ring shaped, and the second electrode and the third electrode do not overlap with each other.

17. The mobile terminal of claim 15, wherein one of the fifth electrode and sixth electrode is ring shaped, and the fifth electrode and sixth electrode do not overlap with each other.

18. The mobile terminal of claim 15, wherein one of the fifth electrode and sixth electrode is ring shaped, and the fifth electrode and sixth electrode do not overlap with each other.

19. An antenna unit, comprising:
an antenna pattern line;
an electrode disposed opposite at least a portion of the antenna pattern line; and
a switch to selectively connect the electrode to a ground to shift a resonant frequency of the antenna pattern.

20. The antenna unit of claim 19, wherein the electrode is disposed in a hole in the antenna pattern line.

21. The antenna unit of claim 19, wherein the electrode comprises a first electrode and a second electrode, and wherein at least one of the first electrode and the second electrode is ring shaped.

22. The antenna unit of claim 21, wherein the ring shaped electrode is at least one of a square ring, a circular ring, and an elliptical ring.

23. The antenna unit of claim 21, wherein the first electrode and the second electrode are disposed parallel to each other and the antenna pattern line.
